(19) United States
(12) Patent Application Publication
(10) Pub. No.: US 2004/0067312 A1
(43) Pub. Date: Apr. 8, 2004

(54) Method for forming thin film and catalyzed treatment solution used therefor

(75) Inventors: Yuichi Sato, Yokohama-shi (JP); Koji Umehara, Atsugi-shi (JP); Kazuki Shinbo, Kurashiki-shi (JP); Akira Yonezawa, Tokyo (JP)

Correspondence Address: Finnegan, Henderson, Farabow,, Garrett & Dunner, L.L.P., 1300 I Street, N.W., Washington, DC, 20005-3315, US

(73) Assignees: KANAGAWA UNIVERSITY; YAMAICHI ELECTRONICS CO., LTD.

(21) Appl. No.: 10/674,551

(22) Filed: Oct. 1, 2003

(30) Foreign Application Priority Data
Oct. 2, 2002 (JP) JP 2002-289934
Aug. 26, 2003 (JP) JP 2003-301971

(51) Int. Cl. B05D 3/04; C23C 18/18

(52) U.S. Cl. 427/301; 427/304; 427/306; 427/443.1; 106/1.11

(57) ABSTRACT

In the catalyst-applying treatment, the sensitization treatment is carried out by dipping the base material which has been subjected to the preliminary treatment in a tin chloride solution applied with a predetermined amount of fluorine type anionic surfactant, and the activation treatment is carried out by dipping the base material which has been subjected to the preliminary treatment in a palladium chloride solution applied with a predetermined amount of fluorine type anionic surfactant.

This application claims priority from Japanese Patent Application Nos. 2002-289934 filed Oct. 2, 2002, and 2003-301971 filed Aug. 26, 2003, which are incorporated hereinto by reference.

### BACKGROUND OF THE INVENTION

1. Field of the Invention

The present invention relates to a method for forming a thin film on a surface of a base made of resinous material, and a catalyzed treatment solution used therefor.

2. Description of the Related Art

As disclosed, for example, in U.S. Pat. Nos. 6,286,207, 6,449,835 and 6,523,256, when a metallic conductive layer is formed on a base of a printed wiring board on which LSI (large scale integration) elements or others are mounted, there may be a case in which a primary coat for the plating is formed on the surface of a resinous base by an electroless plating in a manufacturing process. Such a primary coat for the plating is required to have a sufficient bond strength to the base for ensuring the electric connection of electronic parts with the printed wiring board. To enhance the bond strength between the primary coat for the plating and the base, there is a proposal in Japanese Patent Application Laid-open No. 63-014879 (1988) of a surface-roughening treatment of filled liquid crystal polymer used as a base.

The above-mentioned liquid crystal polymer has the property of low in ability of water since a hydroxyl group having an affinity to water is not included at all in a molecule that make up the liquid crystal polymer and the liquid crystal polymer has no gap for soaking water molecule. Accordingly, when the primary coat for the plating is formed on the base made of liquid crystal polymer by the electroless plating, a plating solution is not uniformly soaked into the base to exhibit a relatively low wettability. As a result, there may be a case in which the bond strength of the plated film to the base is insufficient. Particularly, when the liquid crystal polymer contains no fillers, this phenomenon might occur.

### SUMMARY OF THE INVENTION

In view of the above problems, an object of the present invention is to provide a method for forming a thin film on a surface of a resinous base and a catalyzed treatment solution used therefor, capable of improving the bond strength of the plated film to the base made of liquid crystal polymer.

To achieve the above object, the inventive method for forming a thin film comprises the steps of: carrying out a predetermined preliminary treatment on a resinous base on which the thin film is to be formed, carrying out a catalyst-applying treatment on the preliminarily treated resinous base with a catalyzed treatment solution containing a predetermined amount of fluorine type anionic surfactant, and carrying out an electroless plating on the resinous base applied with the catalyst to form the thin film.

The resinous base may be a liquid crystal film containing no filler.

In the catalyst-applied treatment, a series of processes including a sensitization treatment and an activation treatment may be repeated a plurality of times.

The sensitization treatment may be carried out by immersing the preliminarily treated resinous base in a tin-chloride solution applied with a predetermined amount of fluorine type anionic surfactant, and the activation treatment may be carried out by immersing the preliminarily treated resinous base in a palladium chloride solution applied with a predetermined amount of fluorine type anionic surfactant.

The electroless plating may be carried out by immersing the resinous base applied with catalyst in a copper-plating bath having a relatively low deposition speed.

The copper-plating bath may contain potassium sodium tartrate as complexing agent.

The catalyzed treatment solution in accordance with the present invention comprises a sensitization treatment solution for carrying out the sensitization treatment on a base to be electroless-plated containing a predetermined amount of fluorine type anionic surfactant, and an activation treatment solution for carrying out the activation treatment on the sensitization-treated base containing a predetermined amount of fluorine type anionic surfactant.

As apparent from the above description, according to the method for forming a thin film in accordance with the present invention, since the catalyst-applying treatment is carried out on the preliminary treated resinous base with the catalyzed treatment solution applied with a predetermined amount of fluorine type anionic surfactant when the electroless-plated thin film is formed on a surface of the resinous base, a so-called wettability is improved between the base and the catalyzed treatment solution. Thus, it is possible to enhance the bond strength of the plated film to the liquid crystal base.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 illustrates process drawing in an example of the method for forming a thin film according to the present invention;

FIG. 2 is a perspective view of an appearance of a wiring board on which an embodiment of the method for forming a thin film according to the present invention is applied;

FIG. 3 is characteristic drawing illustrating the relationship between the bond strength of a primary coat for the plating formed by an embodiment of the method for forming a thin film according to the present invention and the plating time; and

FIG. 4 is characteristic drawing illustrating the relationship between the bond strength of a primary coat for the plating formed by an example of a comparative method and the plating time.

### DETAILED DESCRIPTION OF PREFERRED EMBODIMENTS

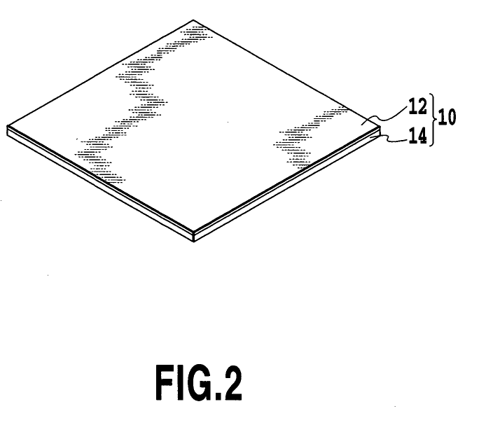

FIG. 2 illustrates an appearance of a wiring board manufactured by the application of one example of the method for forming a thin film according to the present invention.

In FIG. 2, the wiring board 10 includes a base 14 having a surface layer portion on which a copper electro-conductive layer 12 is formed. In this regard, FIG. 2 illustrates a state in which electronic parts are not yet mounted on the wiring board 10.

The base 14 is made from a liquid crystal polymer (LCP) film that does not contain a filler, for example, and having a thickness of 50 μm (manufactured by KURARAY Corp.: Vecstar FA-X100) and the form of a generally square. The electro-conductive layer 12 is comprised, for example, of a primary coat for the plating having a predetermined film thickness and an upper layer having a film thickness larger than that of the primary coat for the plating and layered thereon.

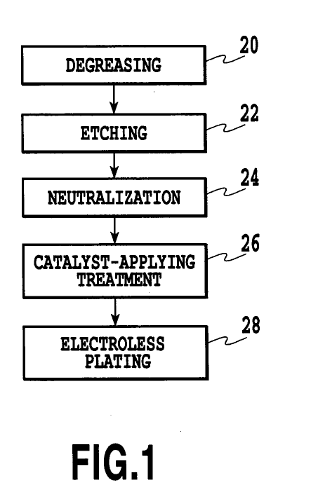

When the base 14 of such a wiring board 10 is manufactured, an embodiment of a method for forming a film according to the present invention used mainly includes a degreasing process 20, an etching process 22, a neutralizing process 24, a catalyst-applying process 26 and an electroless plating process 28, as shown in FIG. 1.

In the degreasing process 20, a base material prepared for forming the base 14 is degreased by dipping the material in a phosphoric acid system degreasing solution (manufactured by EEJA Corp.; Type EETREX15) diluted with ultrapure water in 2 fold dilution factor. For example, the dipping of the base material continues for 10 minutes while ultrasonically agitating the solution. After the degreasing process, the base material is washed for the purpose of avoiding the reduction of the etching effect or others due to the residual degreasing solution.

Next, the etching process 22 is carried out for the purpose of improving the adhesion of the surface of the base material with the primary coat for the plating by the anchoring effect based on forming micro-pores or projections and depressions on the surface of the degreased base material.

The etching process 22 is carried out, for example, by a chemical etching method. That is, the base material is dipped in an alkaline etching solution for a predetermined period. In this regard, the etching method is not limited to the above method but may be a physical etching method, for example.

The etching solution is, for example, a potassium hydroxide solution or a sodium hydroxide solution having a predetermined concentration. The concentration is, for example, 10 mol (M). The etching process is carried out, for example, on condition that the duration of time is for the period of not less than 60 below 180 minutes, or not less than 60 nor more than 120 minutes, preferably not less than 60 nor more than 90 minutes in a temperature-controlled bath in which the temperature of the solution is maintained at 70° C.

It has been confirmed by a studying of the inventors of the present invention that when the concentration is lower than 10M, for example, at 1M or 5M, the number of resultant micro-pores becomes less and the sufficient projections and depressions is not formed on the surface of the base material, but if the etching process continues for a longer period, the sufficient projections and depressions is obtainable. Accordingly, the concentration of the alkaline etching solution should be 10M or higher. Also, it has been confirmed by a studying of the inventors of the present invention that when the concentration is 10M and the solution temperature is lower than 70° C., for example, at 30 or 45° C., the number of resultant micropores becomes less and the sufficient projections and depressions is not formed on the surface of the base material. Accordingly, the temperature of the alkaline etching solution should be 70° C. or higher.

Further, it has been confirmed by a studying of the inventors of the present invention that when the dipping time exceeds, for example, 180 minutes, a size of the resultant micro-pore and projections and depressions becomes relatively larger and the number of micro-pores decreases to deteriorate the adhesion of the primary coat for the plating with the base material. Accordingly, the dipping time should be shorter than 180 minutes.

Next, as shown in FIG. 1, in the neutralizing process 24, the neutralizing treatment is carried out after the etching process 22 on the base material which has been subjected to the etching treatment. Thereafter, the base material is washed so that the plating process is not disturbed by the residual etching solution and/or neutralizing solution.

Next, in the catalyst-applying process 26, the catalyzed treatment is carried out on the base material which has been subjected to the etching treatment and the neutralizing treatment. The catalyzed treatment is a treatment for applying a metal having catalytic activity to the non-active surface of liquid crystal polymer for the purpose of carrying out the electroless plating described later. The catalyzed treatment includes a sensitization treatment and an activation treatment.

The sensitization treatment is carried out by dipping the base material which has been subjected to the etching treatment or others in a predetermined sensitization treatment solution for a given period, for example, for six minutes. The sensitization treatment solution is, for example, a tin chloride dihydrate solution (SnCl₂ 2H₂O). The concentration and the temperature of the tin chloride dihydrate solution are 1 g/l and 70° C., respectively. The tin chloride dihydrate solution is prepared by dissolving tin chloride dihydrate (1 g) in concentrated hydrochloric acid (1 ml), which is then adjusted by ultrapure water.

When a filled liquid crystal polymer is used as the base material, the surface of the liquid crystal polymer may be swelled by the above-mentioned alkaline etching. The fillers are exposed on the surface, and partially come off or elute. As a result, fine projections and depressions are left on the surface, thereby, providing the adhesion between the plated layer and the base material to a certain extent.

However, since the liquid crystal polymer (LCP) film containing no fillers is used as the base material in one embodiment of the method for forming a thin film according to the present invention, it is necessary to devise the preliminary treatment.

To solve such a problem, in one embodiment of the method for forming a thin film in accordance with the present invention, a predetermined amount of surfactant, for example, a fluorine type anionic surfactant such as perfluorononanoic acid (CF₃(CF₂)₇COOH) is applied to the sensitization treatment solution, which the amount is not zero but less than 1 ppm. As a result, by adding 1 ml of the surfactant solution prepared to be 200 ppm, a total amount of the sensitization treatment solution becomes, for example, 200 ml.

The reason why the concentration of the surfactant solution is less than 1 ppm is that it has been confirmed by studying of the inventors of the present invention that the surfactant is difficult to dissolve if the concentration exceeds 1 ppm.

In this regard, the fluorine type anionic surfactant may be composed of ester sulfate (—OSO₃H), sulfonic acid or phosphoric ester or the like in addition to carboxylic acid. In place of hydrogen ion (H⁺), NH₄⁺, K⁺ or Na⁺ may be used as salt.

Further, the fluorine type anionic surfactant may be selected from a group concretely consisting of anions or salts such as fluorine type carboxylic acid —COOM {RfCOOM, RfSO₂N(R′)₂CH₂COOM}, fluorine type ester sulfate —OSO₃M {RfBNR′C₂H₄OSO₃M}, fluorine type sulfonate —SO₃M {RfSO₃M, RfCH₂OCₘH₂ₘSO₃M RfCH₂OCOCH(SO₃M)CH₂COOCH₂Rf} or fluorine type phosphoric ester {RfBN(R′)CₘH₂ₘC(O)P(OH)₂} in addition to carboxylic acid.

In this regard, Rf represents fluorocarbon group obtained by replacing part or all of H in alkyl group with F; B represents CO or SO₂; R′ represents H or lower alkyl group; and M represents H, alkali or alkaline-earth metals.

The activation treatment is carried out by dipping the base material which has been subjected to the etching treatment in a predetermined activation treatment solution for a predetermined period, for example, six minutes. The activation treatment solution is prepared by dissolving palladium chloride (0.1 g) in concentrated hydrochloric acid (0.8 ml), for example, which is then adjusted by ultrapure water. The concentration and temperature of the palladium chloride solution are 0.1 g/l and 70° C., respectively.

Also, the activation treatment solution is added with a predetermined amount of the above-mentioned surfactant, for example, perfluorononanoic acid (CF₃(CF₂)₇COOH) as a fluorine type anionic surfactant, which amount is not zero but less than 1 ppm. As a result, by adding 1 ml of the surfactant solution prepared to be 200 ppm, a total amount of the activation treatment solution becomes, for example, 200 ml.

The series of processes of the sensitization treatment and the activation treatment are continuously repeated twice, respectively, in such a manner that after the first sensitization treatment, the first activation treatment is carried out, and by using again the sensitization treatment solution and the activation treatment solution used in the preceding time, the second activation treatment is successively carried out after the second sensitization treatment is carried out. The reason why the sensitization treatment and the activation treatment are repeated a plurality of times is in that it has been confirmed by studying of the inventors of the present invention that if these treatments are repeated twice, a more amount of plated film deposition is separated out in the electroless plating process as described later than in a case when they are carried out only once. The reason why such a difference in the amount of the deposition generates is thought that while palladium exists as ions and insufficiently exhibits the calatytic activity in the first treatment when the base material is first dipped in the sensitization treatment solution and the activation treatment solution, the palladium remaining as ions is reduced by the second sensitization treatment.

The purpose of applying the surfactant to the sensitization treatment solution and the activation treatment solution is to reduce the surface tension of the solution to improve the wettability between the base material and the catalyzed treatment solution and enhance the permeability of the catalyzed treatment solution to the base material so that the catalyzed treatment solution permeates the interior of the micro-pores. Thereby, the bond strength between the base material and the primary coat for the plating is improved.

Subsequently, in the electroless plating process 28, the electroless plating is carried out on the base material which has been subjected to the catalyst-applying treatment for forming the primary coat for the plating. A copper plating bath is, for example, a low-rate bath using potassium sodium tartrate as a complexing agent. A hydrogen ion concentration pH of the plating bath is set at 11.2. The plating bath is prepared by dissolving potassium sodium tartrate (17 g) in ultrapure water (100 cm³), to which is applied a predetermined amount of 2, −2′ dipyridyl, polyethylene glycol (PEG-1000) and 37% formaldehyde, in which in the solution is dissolved copper sulfate (1.5 g).

In this regard, while the plating bath is the low-rate bath which potassium sodium tartrate is used as a complexing agent in the above mentioned example, the present invention should not be limited thereto but a high-rate EDTA bath (70° C., 2 to 3 μm/h) in which the temperature of the plating bath is lowered by a predetermined value may be used. This is because if the temperature of the plating bath is lowered by approximately 10° C., the plating speed becomes about a half.

If the electroless plating is carried out, for example, at a plating speed of approximately 0.008 μm/min for 300 minutes, the primary coat for the plating of approximately 2.3 μm in thickness having a relatively smooth surface is obtainable.

The reason why the low-rate deposition bath is used is based on a fact that the inconvenience has been confirmed by studying of the inventors of the present invention. The inconvenience are something to the effect that if the electroless plating is carried out in the plating bath having a relatively high deposition rate, a copper does not separate out in the interior of micro-pores in the base material and also the plated film is swollen within 30 minutes. It is thought that a cause of such an inconvenience is that the deposition occurs solely on the surface of the base material since the deposition rate is high and the plating solution does not permeate the interior of the micro-pores.

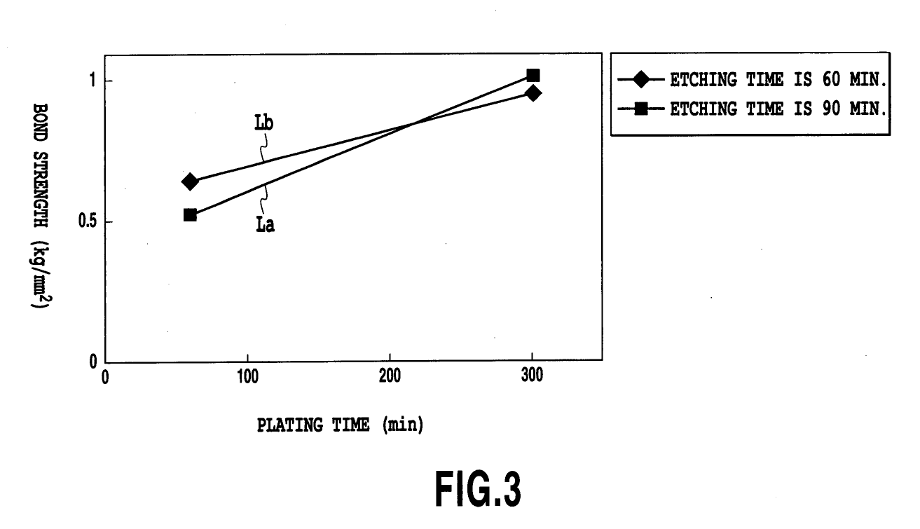

It has been confirmed by studying of the inventors of the present invention that the bond strength between the primary coat for the plating of 2.3 μm in thickness thus formed and the base material is 0.9 kg/mm² when the etching time is 60 minutes, the plating time is 300 minutes and the plating speed is 0.008 μm/min as shown in FIG. 3.

FIG. 3 represents characteristic lines La and Lb plotted on the coordinates in which a vertical axis represents the bond strength (kg/mm²) between the primary coat for the plating and the base material and a horizontal axis represents the plating time (min), illustrating the relationship between the plating time and the bond strength when the plating speed is 0.008 μm/min.

In FIG. 3, the characteristic lines La and Lb depict the bond strength of the primary coat for the plating in accordance with the plating time when the etching time is 90 minutes and 60 minutes, respectively. The bond strength was measured by using a tensile tester (manufactured by MARUBISHI KAGAKU KIKAI SEISAKUSHO: Type SV-950)

As apparent from the characteristic lines La and Lb, the bond strength becomes larger as the etching time increases, and when the plating time is 300 minutes, the bond strength is larger when the etching time is 90 minutes than when the etching time is 60 minutes.

Subsequently, another electroless plating treatment is carried out for a predetermined period in the same plating bath as before for forming an upper layer laminated on the primary coat for the plating under the predetermined conditions. Thereby, the upper layer is laminated on the primary coat for the plating and the electro-conductive layer 12 is completed on the base material. Thus, the wiring board 10 is obtained.

Further, a primary coat for the plating obtained by a method different from the method for forming a thin film in accordance with the present invention (hereinafter referred to as Comparative example Sa) will be described in comparison with the preceding Example.

In Comparative example Sa, a base material made of liquid crystal polymer film of 50 μm in thickness (manufactured by KURARAY Corp.: Type Vecstar FA-X100) and cut to have a generally square shape is used, which is the same as that used in the preceding Example.

In Comparative example Sa, the degreasing process 20, the etching process 22, the neutralizing process 24 and the electroless plating process 28 are subsequently carried out in the same order as in the preceding Example. In this regard, in the etching process 22, the process is carried out for a etching time of 30 minutes and 60 minutes, respectively.

In this regard, in the catalyst-applying process 26, a catalyzed treatment solution containing no surfactant as in the preceding Example, that is, tin chloride solution (the concentration of 1 g/l) and palladium chloride solution (the concentration of 0.1 g/l) applied with no surfactant, is used, and the catalyst-applying treatment is carried out twice therein at a solution temperature of 70° C. for a dipping time of 6 minutes as in the preceding Example.

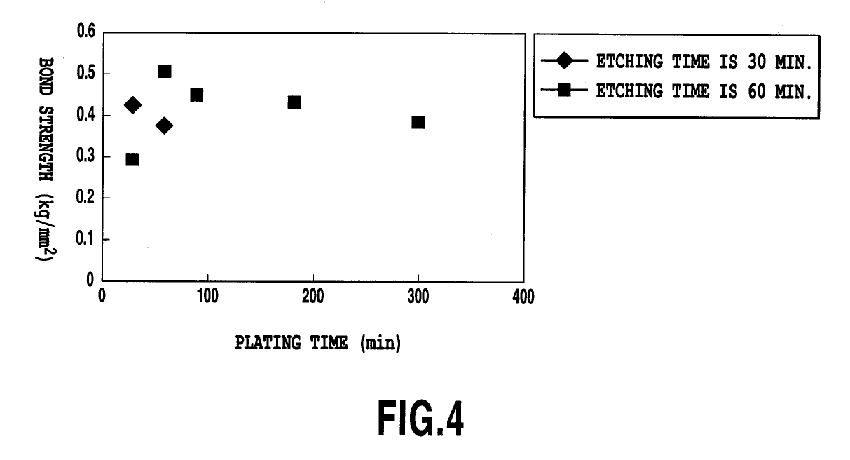

FIG. 4 represents illustrates the relationship between the plating time and the bond strength in accordance with the etching times in Comparative example Sa plotted on the coordinates in which a vertical axis represents the bond strength (kg/mm²) and a horizontal axis represents the plating time (min).

As a result, as apparent from the comparison of FIG. 4 with the characteristic lines in FIG. 3, if the etching time is 60 minutes, the bond strength is approximately 0.4 kg/mm² in Comparative example Sa, while it is 0.9 kg/mm² in Example of the present invention which is more than about twice greater than the former. Accordingly, it has been confirmed that the adhesion property of the primary coat for the plating formed by the method for forming a thin film in accordance with the present invention is apparently more excellent than that obtained by Comparative example Sa.

When a copper-clad laminated plate having a copper conductive layer of several μm in thickness by a embodiment of the method for forming a thin film in accordance with the present invention, since the thickness of the conductive layer is relatively thin and the bond strength is approximately twice that obtained without applying a surfactant, micro-circuit patterns are easily realized.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A method for forming a thin film comprising the steps of:
carrying out a predetermined preliminary treatment on a resinous base on which said thin film is to be formed,
carrying out a catalyst applying treatment on said resinous substrate which has been subjected to said preliminary treatment by a catalyzed treatment solution applied with a predetermined amount of fluorine type anionic surfactant, and
carrying out an electroless plating on said resinous substrate which has been subjected to said catalyst-applying treatment to form said thin film.

2. A method for forming a thin film as claimed in claim 1, wherein said resinous base is a liquid crystal polymer film containing no fillers.

3. A method for forming a thin film as claimed in claim 1, wherein in said catalyst-applying treatment, a series of processes including a sensitization treatment and an activation treatment are continuously repeated a plurality of times.

4. A method for forming a thin film as claimed in claim 3, wherein said sensitization treatment is carried out by dipping said resinous base which has been subjected to said preliminary treatment in a tin chloride solution applied with the predetermined amount of fluorine type anionic surfactant, and said activation treatment is carried out by dipping said resinous base which has been subjected to said preliminary treatment in a palladium chloride solution applied with the predetermined amount of fluorine type anionic surfactant.

5. A method for forming a thin film as claimed in claim 1, wherein said electroless plating is carried out by dipping said resinous base which has been subjected to said catalyst-applying treatment in a copper plating bath having a relatively low deposition speed.

6. A method for forming a thin film as claimed in claim 5, wherein said copper plating bath is a copper plating bath in which potassium sodium tartrate is contained as a complexing agent.

7. A catalyzed treatment solution comprising:
a sensitization treatment solution containing a predetermined amount of fluorine type anionic surfactant, for carrying out said sensitization treatment on a base to be subjected to an electroless plating treatment, and
an activation treatment solution containing the predetermined amount of fluorine type anionic surfactant, for carrying out said activation treatment on said base which has been subjected to said sensitization treatment.
